(19) United States
(12) Patent Application Publication
(10) Pub. No.: US 2019/0123458 A1
(43) Pub. Date: Apr. 25, 2019

(54) SOCKET

(71) Applicant: OMRON Corporation, KYOTO (JP)

(72) Inventors: Yoshihiro AZUMA, Yamaga-shi (JP); Kiyokazu MATSUNAGA, Kumamoto-shi (JP); Hiroshi HASHIMOTO, Kumamoto-shi (JP); Keisuke YANO, Kikuchi-shi (JP)

(73) Assignee: OMRON Corporation, KYOTO (JP)

(21) Appl. No.: 16/133,641

(22) Filed: Sep. 17, 2018

(30) Foreign Application Priority Data
Oct. 23, 2017 (JP) 2017-204717

(51) Int. Cl. H01R 4/2429; H01R 9/24

(52) U.S. Cl. CPC H01R 4/2429; H01R 9/2425

(57) ABSTRACT

Provided is a socket capable of efficiently and easily connecting an external wiring connection terminal and an electrical device terminal connection terminal and reducing manufacturing cost and the number of steps. The socket includes an external wiring connection terminal which is connected to an external wiring and an electrical device terminal connection terminal which is connected to an electrical device terminal. The external wiring connection terminal and the electrical device terminal connection terminal are electrically connected by a bar-shaped wire of which a shape is fixed to a predetermined shape.

### CROSS-REFERENCE TO RELATED APPLICATION

This application claims the priority benefit of Japanese application serial no. 2017-204717, filed on Oct. 23, 2017. The entirety of the above-mentioned patent application is hereby incorporated by reference herein and made a part of this specification.

### BACKGROUND

### Technical Field

The disclosure relates to a socket having an external wiring connection terminal which is connected to an external wiring and an electrical device terminal connection terminal which is connected to an electrical device terminal.

### Description of Related Art

For example, Japanese Laid-open No. 2003-346939 discloses a socket having an external wiring connection terminal which is connected to an external wiring, and an electrical device terminal connection terminal which is connected to an electrical device terminal. In the socket disclosed in Japanese Laid-open No. 2003-346939, the external wiring connection terminal and the electrical device terminal connection terminal are connected by a coated lead wire, and the lead wire is soldered to both the external wiring connection terminal and the electrical device terminal connection terminal. Therefore, it takes time to assemble them. Further, the lead wire is not suitable for automatic assembly because a shape thereof is not fixed and it is easily deformed by its own weight or an external force.

Therefore, in order to solve this problem, a method in which a connection between the external wiring connection terminal and the electrical device terminal connection terminal is made by a flat plate punched member formed of a metal plate which is punched and bent using a mold has been proposed.

In the socket according to the related art configured to connect the terminals with a flat plate punched member formed of metal, various types of flat plate punched members having complicated shapes are required according to wiring positions. For example, shapes of the flat plate punched member may be 8 types. Therefore, the number of mold surfaces required to manufacture each of the flat plate punched materials is also increased to, for example, 16 according to the large number of types of the flat plate punched members. In addition, there is a lot of material loss due to punching, and as a result, manufacturing cost of the socket increases.

Further, as the number of types of flat punching member increases, since it is necessary to position and assemble flat plate punching members of different kinds at correct positions, there is a problem that more time is taken for assembly, and a workload reduction effect is small, when compared with an inter-terminal connecting member made of a coated lead wire. Furthermore, if the number of types of flat punching member is large, the structure/control of the assembling apparatus becomes complicated, which is not suitable for automatic assembly.

### SUMMARY

An aspect of the present disclosure provides a socket which allows efficient and simple connection between a connection terminal for an external wiring and a connection terminal for an electrical device terminal, and in which costs and a number of operations therefor are reduced.

According to an aspect of the disclosure, there is provided a socket including an external wiring connection terminal which is connected to an external wiring and an electrical device terminal connection terminal which is connected to an electrical device terminal, wherein the external wiring connection terminal and the electrical device terminal connection terminal are electrically connected by a bar-shaped wire of which a shape is fixed to a predetermined shape.

### BRIEF DESCRIPTION OF THE DRAWINGS

FIG. 1 is an exploded perspective view showing an example of a configuration of a socket in a first embodiment of the disclosure.

FIG. 2 is a perspective view showing an overall configuration of the socket.

FIG. 3 is a perspective view showing an example of the socket except for a rear cover, a molded support, and a front cover.

FIG. 4 is a perspective view showing an example of the molded support and a bar-shaped wire of the socket seen from a rear side.

FIG. 5 is a perspective view showing an example of the socket except for the front cover and the molded support.

FIG. 6 is a perspective view showing an example of a configuration of a socket according to a second embodiment of the disclosure.

FIG. 7 is a perspective view showing an example of the molded support and the bar-shaped wire of the socket seen from a rear side.

### DESCRIPTION OF THE EMBODIMENTS

According to an aspect of the disclosure, there is provided a socket including an external wiring connection terminal which is connected to an external wiring and an electrical device terminal connection terminal which is connected to an electrical device terminal, wherein the external wiring connection terminal and the electrical device terminal connection terminal are electrically connected by a bar-shaped wire of which a shape is fixed to a predetermined shape.

According to such a configuration, the external wiring connection terminal and the electrical device terminal connection terminal are electrically connected by the bar-shaped wire of which the shape is fixed in a predetermined shape. The bar-shaped wire of which the shape is fixed to a predetermined shape is different from a coated lead wire of which a shape is not fixed and which is easily deformed by its own weight or an external force. As a result, since the bar-shaped wire of which the shape is fixed to a predetermined shape can be formed of a bare metal wire, automatic assembly becomes possible.

On the other hand, conventionally, when a flat plate punched member is used as an inter-terminal connection member, since the flat plate punched member has a complicated shape and many types, manufacturing cost is increased, and an effect of reducing the number of steps is also small.

In response, in the socket according to the aspect of the disclosure, the inter-terminal connection member is formed of the bar-shaped wire of which the shape is fixed in a predetermined shape.

For example, in the flat plate punched member, a pair of bilaterally symmetrical flat plate punched members may be required. However, when the inter-terminal connection member is formed of the bar-shaped wire, the bar-shaped wire itself can be formed into a symmetrical shape. As a result, it is possible to reduce material cost associated with the large number of types of inter-terminal connection members. Further, since the number of types of inter-terminal connection members can be reduced, it is not necessary to select the type of bar-shaped wire, and the number of steps can be reduced.

Therefore, it is possible to provide a socket which can efficiently and easily connect between the external wiring connection terminal and the electrical device terminal connection terminal, thereby reducing the manufacturing cost and the number of steps.

In the socket according to the aspect of the disclosure, the bar-shaped wire may be formed in a U-shape.

Accordingly, the bar-shaped wire is formed in such a way that the shape thereof is fixed in a U shape as a predetermined shape. Therefore, for example, it is possible to connect the bar-shaped wire to the external wiring connection terminal and the electrical device terminal connection terminal by pushing both ends of the bar-shaped wire fixed in a U shape upon connection to the external wiring connection terminal and the electrical device terminal connection terminal in the inter-terminal connection member.

As a result, even in the case of automatic assembly, the bar-shaped wire can be connected to the external wiring connection terminal and the electrical device terminal connection terminal by moving the bar-shaped wire in one direction. Further, when the inter-terminal connection member is formed into a bar-shaped wire, the number of types of inter-terminal connection member can be reduced. Therefore, the automatic assembly is facilitated, the number of steps can be reduced and the manufacturing cost can be reduced.

In the socket according to the aspect of the disclosure, a molded product which supports the bar-shaped wire may be provided, and the molded product may have a groove or hole which fixes the bar-shaped wire in a stationary state in a direction perpendicular to a direction in which the bar-shaped wire is inserted into the molded product.

For example, when a leg of the bar-shaped wire of which the shape is fixed in a U shape is long, there is a likelihood that the leg of the bar-shaped wire will break or bend during insertion of the bar-shaped wire. Therefore, in the socket according to the aspect of the disclosure, the molded product which supports the bar-shaped wire is provided, and the molded product has the groove or hole which fixes the bar-shaped wire in the stationary state in the direction perpendicular to the direction in which the bar-shaped wire is inserted into the molded product. Accordingly, the bar-shaped wire does not move in the direction perpendicular to the direction in which the bar-shaped wire is inserted into the molded product due to the groove or hole of the molded product.

Therefore, it is possible to prevent the leg of the bar-shaped wire from being broken or bent when the bar-shaped wire is inserted.

In the socket according to the aspect of the disclosure, a plurality of bar-shaped wires may be provided, and the molded product may support the bar-shaped wires to have a height difference between the bar-shaped wires in a direction in which the bar-shaped wire is inserted into the molded product.

For example, when the plurality of bar-shaped wires are provided and the number of bar-shaped wires inside the socket increases, there is a possibility that the bar-shaped wires formed of, for example, bare wires come into contact with each other. In this case, when the plurality of bar-shaped wires are provided at the same height positions, there is a high possibility that the bar-shaped wires come into contact with each other. In response, in the socket according to the aspect of the disclosure, the molded product supports the bar-shaped wires to have a height difference between the bar-shaped wires in a direction in which the bar-shaped wire is inserted into the molded product.

As a result, since the heights of the respective bar-shaped wires are different when the bar-shaped wires are installed and fixed, the possibility that the respective bar-shaped wires come into contact with each other can be reduced.

In the socket according to the aspect of the disclosure, a plurality of bar-shaped wires may be provided, and the molded product may have insulation walls which insulate the plurality of bar-shaped wires.

For example, when the plurality of bar-shaped wires are provided and the number of bar-shaped wires inside the socket increases, there is a possibility that the bar-shaped wires formed of, for example, a bare wire will come into contact with each other. Therefore, in the socket according to the aspect of the disclosure, the molded product has the insulation walls which insulate the plurality of bar-shaped wires. Therefore, it is possible to prevent short-circuiting of the bar-shaped wires with each other due to the insulation walls.

In the socket according to the aspect of the disclosure, each of the external wiring connection terminal and the electrical device terminal connection terminal may have a bar-shaped wire end connection hole which enables electrical connection by inserting each end of the bar-shaped wire.

Therefore, when the bar-shaped wire is inserted to connect the bar-shaped wire to the external wiring connection terminal and the electrical device terminal connection terminal, the bar-shaped wire can be connected to the external wiring connection terminal and the electrical device terminal connection terminal merely by inserting the bar-shaped wire into the respective bar-shaped wire end connection holes of the external wiring connection terminal and the electrical device terminal connection terminal.

Therefore, it is easy to connect the bar-shaped wire to the external wiring connection terminal and the electrical device terminal connection terminal, and it is possible to reduce the number of steps.

In the socket according to the aspect of the disclosure, a cover body having an insulating property may be provided, and the cover body may have a protrusion which fixes a position of the bar-shaped wire when the cover body is closed.

Accordingly, when the bar-shaped wire is connected to the external wiring connection terminal and the electrical device terminal connection terminal and then covered with the cover body, the protrusion of the cover body fixes the position of the bar-shaped wire. Therefore, it is possible to prevent disconnection of the bar-shaped wire from the external wiring connection terminal and the electrical device terminal connection terminal. Further, when the bar-shaped wire is connected to the external wiring connection terminal, for example, it can be soldered to the external wiring connection terminal while the bar-shaped wire is placed on the protrusion of the cover body. As a result, it is easy to solder the bar-shaped wire to the external wiring connection terminal.

According to the aspect of the disclosure, it is possible to provide a socket capable of efficiently and easily connecting the external wiring connection terminal with the electrical device terminal connection terminal and reducing manufacturing cost and the number of steps.

Hereinafter, an embodiment according to an aspect of the disclosure (hereinafter, also referred to as “this embodiment”) will be described with reference to the drawings.

### Application Example

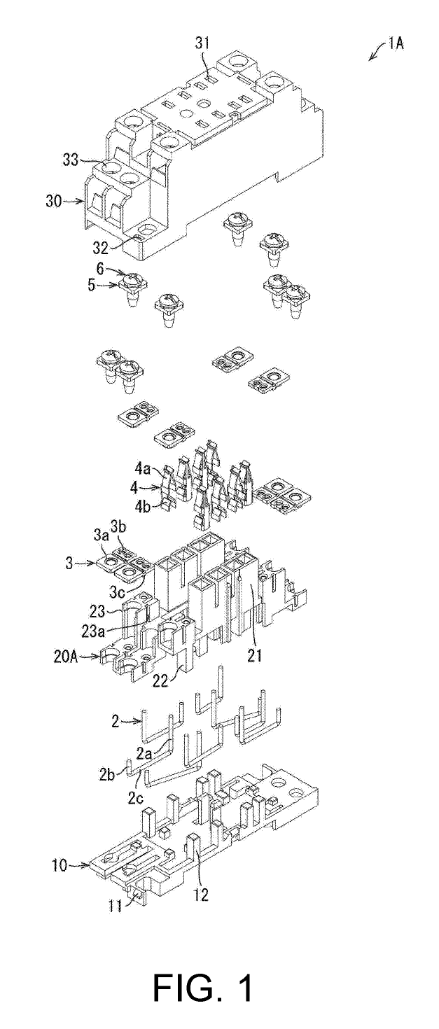

First, an example of a situation to which the disclosure is applied will be described with reference to FIG. 1. FIG. 1 illustrates an example of a socket 1A according to an embodiment of the disclosure and is an exploded perspective view showing a configuration of the socket 1A.

As shown in FIG. 1, the socket 1A according to an aspect of the disclosure includes an external wiring connection terminal 3 which is connected to an external wiring, and an electrical device terminal connection terminal 4 which is connected to an electrical device terminal. A bar-shaped wire 2 of which a shape is fixed to a predetermined shape is electrically connected between the external wiring connection terminal 3 and the electrical device terminal connection terminal 4.

According to such a configuration, the external wiring connection terminal 3 and the electrical device terminal connection terminal 4 are electrically connected by the bar-shaped wire 2 of which the shape is fixed. Therefore, the bar-shaped wire 2 of which the shape is fixed is not bent, unlike a coated lead wire. As a result, the bar-shaped wire 2 with the fixed shape can be formed of a bare metal wire, and thus automatic assembly is possible.

Further, in this configuration, since an inter-terminal connection member is configured with the bar-shaped wire 2, the bar-shaped wire 2 itself can be formed in a bilaterally symmetrical shape. As a result, it is possible to reduce manufacturing cost by reducing the number of types of inter-terminal connection members, compared with the conventional flat plate punched members. In addition, since it is not necessary to select the type of the inter-terminal connection members, it is possible to reduce the number of steps.

Accordingly, it is possible to provide a socket 1A capable of efficiently and easily connecting the external wiring connection terminal 3 with the electrical device terminal connection terminal 4 and reducing manufacturing cost and the number of steps.

### Configuration Example

### First Embodiment

The embodiment of the disclosure will be described with reference to FIGS. 1 to 5 as follows.

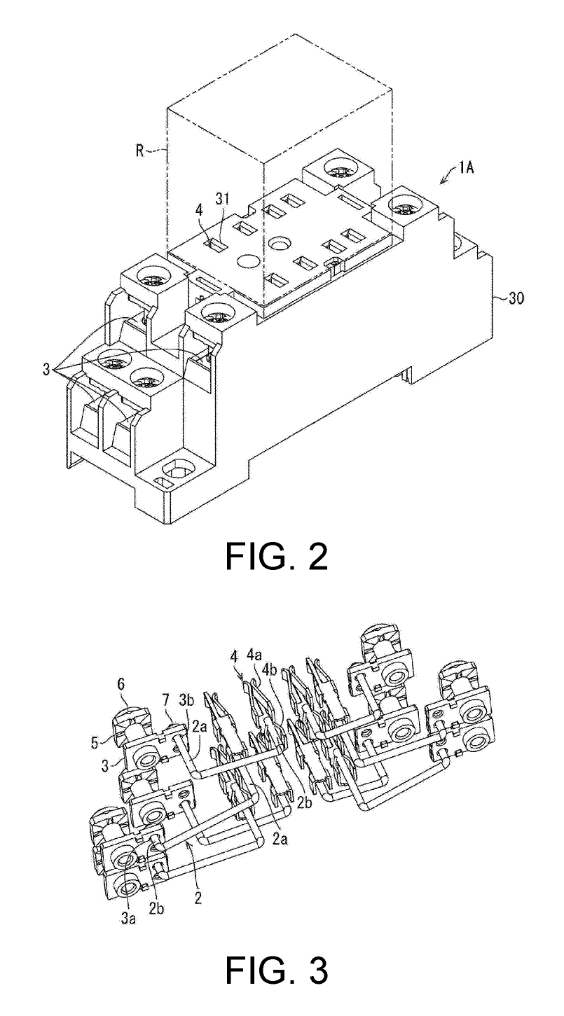

An overall configuration of the socket 1A of this embodiment will be described with reference to FIG. 2. FIG. 2 is a perspective view showing the overall configuration of the socket 1A of this embodiment. In this embodiment, an upper side of the drawing in FIG. 2 (the side on which a relay R indicated by a dotted line is mounted) is referred to as a front side, and a lower side of the drawing in FIG. 2 is referred to as a rear side or a rear surface side.

As shown in FIG. 2, the socket 1A of this embodiment has a substantially rectangular parallelepiped shape and has a total of eight external wiring connection terminals 3, i.e., four at each of both ends thereof in a longitudinal direction. Further, eight electrical device terminal connection terminals 4 are provided therein, and the electrical device terminal connection terminals 4 are formed to be exposed through terminal insertion holes 31 formed in a front surface of a front cover 30 of the socket 1A. As described above, the socket 1A of this embodiment is an 8-terminal type socket.

As shown in FIG. 2, in this embodiment, an electrical device, for example, a relay R, is installed on a front surface of the socket 1A. When the relay R is installed on the socket 1A, a connection terminal (not shown) which is an electrical device terminal of the relay R is inserted into the terminal insertion hole 31 of the front cover 30. Thus, the connection terminal of the relay R is electrically connected to the electrical device terminal connection terminals 4. Further, in the socket 1A of this embodiment, it is assumed that the relay R as an electrical device is installed on the socket 1A. However, in this embodiment of the disclosure, the number of terminals or the like is not necessarily limited thereto, and for example, an arbitrary electrical device such as a timer may also be installed on the socket.

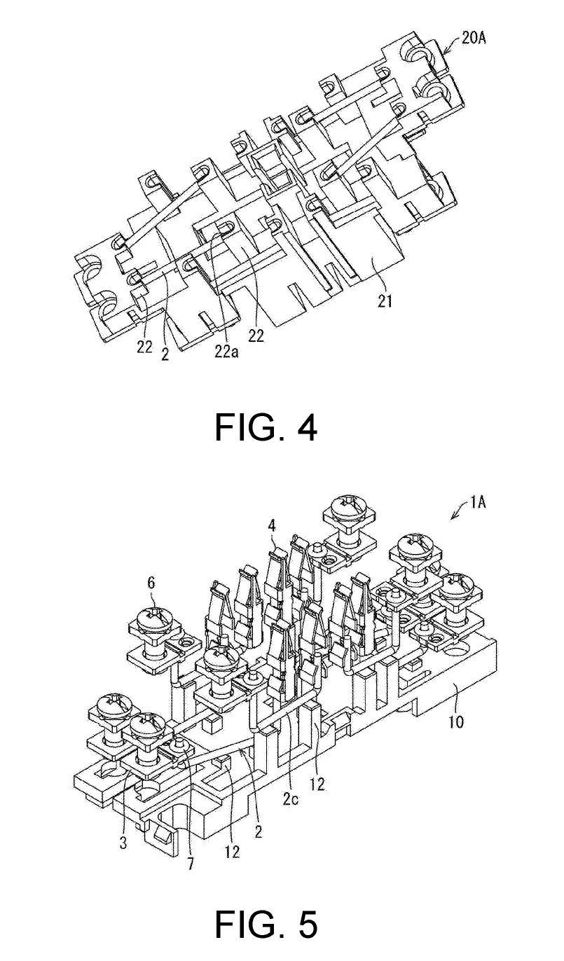

An internal configuration of the socket 1A will be described with reference to FIG. 1 and FIGS. 3 to 5. FIG. 1 is an exploded perspective view showing the configuration of the socket 1A in this embodiment. FIG. 3 is a perspective view showing an example of the socket 1A except for a rear cover 10, a molded support 20A, and a front cover 30. FIG. 4 is a perspective view showing an example of the molded support 20A and the bar-shaped wire 2 of the socket 1A seen from the rear side. FIG. 5 is a perspective view showing an example of the socket 1A except for the front cover 30 and the molded support 20A.

As shown in FIG. 1, the socket 1A of this embodiment has the rear cover 10 provided on the lower side and the front cover 30 provided on the upper side. These rear cover 10 and front cover 30 are formed of a resin and have insulating properties. The rear cover 10 and the front cover 30 can be integrally installed to each other by inserting a claw 11 of the rear cover 10 into a claw hole 32 of the front cover 30.

The molded support 20A as a molded body, the bar-shaped wire 2 supported by the molded support 20A, the external wiring connection terminal 3, the electrical device terminal connection terminal 4, and a washer 5 are provided inside the socket 1A covered by the rear cover 10 and the front cover 30.

The bar-shaped wire 2 is a member which connects the external wiring connection terminal 3 and the electrical device terminal connection terminal 4. In this embodiment, the bar-shaped wire 2 is formed of, for example, a bar-shaped bare conducting wire. A thickness of the conducting wire is, for example, about 1.5 mm. A cross section of the bar-shaped wire 2 may be a circular, elliptical or polygonal shape. In this embodiment, eight bar-shaped wires 2 are provided corresponding to the number of external wiring connection terminals 3 and electrical device terminal connection terminals 4.

In this embodiment, the shape of the bar-shaped wire 2 is fixed particularly in a predetermined shape (for example, a U-shape). That is, the bar-shaped wire 2 includes a horizontal portion 2c and a leg which hangs down from each end of the horizontal portion 2c. The bar-shaped wire 2 is formed of a single wire having a thickness which is not easily deformed due to its own weight or an external force at the time of assembly, rather than a flexible stranded wire. Accordingly, the U-shape of the bar-shaped wire 2 is not easily changed. Further, in the aspect of the disclosure, the bar-shaped wire 2 need not necessarily have a U-shape.

In this embodiment, for example, a length of the leg in the bar-shaped wire 2 having the U-shape is different from each other and the bar-shaped wire 2 has a long leg 2a and a short leg 2b. A length of the horizontal portion 2c of the bar-shaped wire 2 is different according to a connection position. Further, in this embodiment, the connection by a plurality of bar-shaped wires 2 is divided into two cases, i.e., a case in which the long leg 2a of the bar-shaped wire 2 is connected to the external wiring connection terminal 3 and the short leg 2b of the bar-shaped wire 2 is connected to the electrical device terminal connection terminal 4, and a case in which the short leg 2b of the bar-shaped wire 2 is connected to the external wiring connection terminal 3 and the long leg 2a of the bar-shaped wire 2 is connected to the electrical device terminal connection terminal 4. Therefore, height positions of the horizontal portions 2c of the plurality of bar-shaped wires 2 are different from each other, and as a result, the horizontal portions 2c of the bar-shaped wires 2 are prevented from coming into contact with each other.

As shown in FIG. 3, the external wiring connection terminal 3 is connected to the external wiring (not shown) and connected to the bar-shaped wire 2. In the embodiment, as shown in FIG. 1, four external wiring connection terminals 3 are provided at one end of the socket 1A in the longitudinal direction due to a step difference formed in forward and backward directions and two positions shifted in left and right directions. Additionally, four external wiring connection terminals 3 are also provided at the other end of the socket 1A in the longitudinal direction symmetrically with the external wiring connection terminals 3 formed at the one end due to the step difference formed in the forward and backward directions and two positions shifted in the left and right directions. Therefore, in this embodiment, a total of eight external wiring connection terminals 3 are provided. The number thereof corresponds to the number of connection terminals of the relay R described above.

As shown in FIG. 1, the external wiring connection terminal 3 has a screw hole 3a and a bar-shaped wire insertion hole 3b. A screw 6 inserted through a screw insertion hole 33 formed in the front cover 30 is screwed into the screw hole 3a via the washer 5. As a result, when an external wiring which is not shown is connected to the external wiring connection terminal 3, the external wiring is wound around the screw 6, and the external wiring is then fixed while placed between the screw hole 3a and the wafer 5.

As shown in FIG. 3, the bar-shaped wire insertion hole 3b is a hole into which the long leg 2a or the short leg 2b of the bar-shaped wire 2 is inserted. Further, the long leg 2a or the short leg 2b of the bar-shaped wire 2 which has passed through the bar-shaped wire insertion hole 3b of the external wiring connection terminal 3 is soldered with, for example, solder 7.

As shown in FIG. 1, on the front side in the electrical device terminal connection terminal 4, a relay connection terminal clamping plate spring portion 4a in which two plate springs are piled up is disposed to sandwich a band-shaped connection terminal (not shown) of the relay R. Further, on the rear side in the electrical device terminal connection terminal 4, a bar-shaped wire leg clamping plate spring portion 4b in which two plate springs are piled up is disposed to sandwich the long leg 2a or the short leg 2b of the bar-shaped wire 2.

Accordingly, the connection terminal of the relay R is electrically connected to the electrical device terminal connection terminal 4 by sandwiching the connection terminal (not shown) of the relay R inserted into the terminal insertion hole 31 of the front cover 30 between the two plate springs of the relay connection terminal clamping plate spring portion 4a. Further, the bar-shaped wire 2 is electrically connected to the electrical device terminal connection terminal 4 by inserting the long legs 2a or the short legs 2b of the bar-shaped wire 2 into the bar-shaped wire leg clamping plate spring portion 4b and sandwiching it between the two plate springs.

As shown in FIG. 1, the molded support 20A is formed of a resin molded product having an insulating property and supports and fixes the electrical device terminal connection terminal 4, the bar-shaped wire 2 and the external wiring connection terminal 3 at predetermined positions.

As shown in FIG. 1, eight tubular fitting portions 21 which have a square tubular shape and in which both front and rear ends are open are formed on an upper side of a center portion of the molded support 20A to fit the electrical device terminal connection terminal 4. Therefore, since the electrical device terminal connection terminal 4 is inserted from the front side into the tubular fitting portion 21 and is in a fitted state, the electrical device terminal connection terminal 4 is held in the tubular fitting portion 21 of the molded support 20A without moving in a lateral direction. A locking portion (not shown) is provided in a lower portion in the tubular fitting portion 21, and thus the electrical device terminal connection terminal 4 is locked to the locking portion (not shown) when the electrical device terminal connection terminal 4 is inserted from a front opening of the tubular fitting portion 21 and disposed in the tubular fitting portion 21. Therefore, the electrical device terminal connection terminal 4 does not move any more to the rear side. A front end of the electrical device terminal connection terminal 4 which is disposed inside the tubular fitting portion 21 is locked to the front cover 30. Therefore, the electrical device terminal connection terminal 4 disposed inside the tubular fitting portion 21 does not move to the front side.

Further, as shown in FIGS. 1 and 4, a bar-shaped wire leg holding portion 22 for holding the long leg 2a and the short leg 2b of the bar-shaped wire 2 stands up on the lower side of the molded support 20A. A groove 22a which fixes the bar-shaped wire 2 in a stationary state in a direction perpendicular to a direction in which the bar-shaped wire 2 is inserted into the molded support 20A is formed in the bar-shaped wire leg holding portion 22. Accordingly, the bar-shaped wire 2 does not move in the direction perpendicular to the direction in which the bar-shaped wire 2 is inserted into the molded support 20A. As a result, for example, when the bar-shaped wire 2 is inserted, it is possible to prevent the long legs 2a and the short legs 2b from being broken or bent. In addition, the groove 22a prevents the bar-shaped wire 2 from being inclined or deformed and prevents the adjacent bar-shaped wires 2 from coming into contact with each other. In this embodiment, the groove 22a which fixes the bar-shaped wire 2 in the stationary state in the direction perpendicular to the direction in which the bar-shaped wire 2 is inserted into the molded support 20A is formed in the bar-shaped wire leg holding portion 22. However, in the aspect of the disclosure, the disclosure is not necessarily limited thereto, and a hole may be formed in the bar-shaped wire leg holding portion 22. This also makes it possible to fix the bar-shaped wire 2 in the stationary state in the direction perpendicular to the direction in which the bar-shaped wire 2 is inserted into the molded support 20A.

Further, as shown in FIG. 1, an external wiring connection terminal placing portion 23 which installs the external wiring connection terminal 3 is formed at both ends of the molded support 20A in the longitudinal direction. Additionally, a placing portion groove 23a extending in the front-rear direction is formed in both side surfaces of the external wiring connection terminal placing portion 23. Therefore, since a fitting protrusion 3c of the external wiring connection terminal 3 is fitted to the placing portion groove 23a, the external wiring connection terminal 3 can be fixed to the external wiring connection terminal placing portion 23.

As shown in FIG. 1, a rear cover protruding portion 12 as a protrusion stands up on the rear cover 10. Accordingly, when the bar-shaped wire 2 is connected to the external wiring connection terminal 3 and the electrical device terminal connection terminal 4 and then covered with the rear cover 10, for example, a tip end of the rear cover protruding portion 12 comes into contact with the bar-shaped wire 2 to fix a position of the bar-shaped wire 2. Therefore, it is possible to prevent disconnection of the bar-shaped wire 2 from the external wiring connection terminal 3 and the electrical device terminal connection terminal 4.

In this embodiment, when with the rear cover 10 is covered, the rear cover protruding portion 12 is brought into contact with the bar-shaped wire 2, for example. However, in the aspect of the disclosure, the disclosure is not limited thereto, and there may be a slightly pressed state therebetween. Also, there does not necessarily have to be contact and there may be a small gap therebetween. This is because it is thought that the long legs 2a and the short legs 2b of the bar-shaped wire 2 will not become disconnected from the external wiring connection terminal 3 or the electrical device terminal connection terminal 4 as long as the distance therebetween is a small gap or less. As described above, the rear cover 10 includes the rear cover protruding portion 12 that fixes (temporarily fixes) the positions of the plurality of bar-shaped lines 2 in a covered state.

Next, a method of assembling the socket 1A according to this embodiment will be described.

First, as shown in FIG. 1, the electrical device terminal connection terminal 4 is inserted from the front side into the tubular fitting portion 21 of the molded support 20A. Then, one of the long leg 2a and the short leg 2b of the bar-shaped wire 2 is inserted from the rear side of the tubular fitting portion 21. Therefore, as shown in FIG. 3, one of the long leg 2a and the short leg 2b of the bar-shaped wire 2 is elastically fixed and electrically connected to the bar-shaped wire leg clamping plate spring portion 4b of the electrical device terminal connection terminal 4 by one of the long leg 2a and the short leg 2b of the bar-shaped wire 2 being clamped by the bar-shaped wire leg clamping plate spring portion 4b of the electrical device terminal connection terminal 4.

Further, when one of the long leg 2a and the short leg 2b of the bar-shaped wire 2 is inserted from the lower side of the tubular fitting portion 21, the other one of the long leg 2a and the short leg 2b of the bar-shaped wire 2 is adapted to pass along the groove 22a of the bar-shaped wire leg holding portion 22 of the molded support 20A, as shown in FIG. 4. Then, as shown in FIG. 1, the external wiring connection terminal 3 is placed on the external wiring connection terminal placing portion 23 of the molded support 20A, and the other one of the long leg 2a and the short leg 2b of the bar-shaped wire 2 is adapted to pass through the bar-shaped wire insertion hole 3b of the external wiring connection terminal 3. Thereafter, as shown in FIG. 5, the other one of the long leg 2a and the short leg 2b of the bar-shaped wire 2 is soldered to the external wiring connection terminal 3 with the solder 7. Here, in this embodiment, when the soldering with the solder 7 is performed, the tip end of the rear cover protruding portion 12 of the rear cover 10 is brought into contact with the horizontal portion 2c of the bar-shaped wire 2 while the other one of the long leg 2a and the short leg 2b of the bar-shaped wire 2 passing through the bar-shaped wire insertion hole 3b of the external wiling connection terminal 3. Accordingly, since the bar-shaped wire 2 is placed on the rear cover protruding portion 12, the bar-shaped wire 2 is temporarily fixed. As a result, it is possible to easily perform the soldering with the solder 7.

Next, in this state, the front cover 30 faces the rear cover 10 side, and the front cover 30 is joined to the rear cover 10 from the front side. At this time, since the claw 11 of the rear cover 10 is inserted into the claw hole 32 of the front cover 30, they are integrally held in a joined state. At this time, in this embodiment, the state in which the tip end of the rear cover protruding portion 12 of the rear cover 10 is in contact with the horizontal portion 2c of the bar-shaped wire 2 is maintained. As a result, it is possible to prevent the disconnection of the bar-shaped wire 2 from the external wiring connection terminal 3 and the electrical device terminal connection terminal 4.

Thereafter, as shown in FIG. 1, an external wiring (not shown) is connected to the external wiring connection terminal 3 with the screw 6. Eventually, as shown in FIG. 2, for example, the connection terminal of the relay R is inserted into the terminal insertion hole 31 of the front cover 30 from the front side of the socket 1A. Therefore, the relay R is electrically connected to the electrical device terminal connection terminal 4, and the relay R can be brought into a usable state.

When the relay R fails, since it is sufficient to remove the failed relay R from the socket 1A and replace it with another relay R, the replacement work is also easy.

As described above, the socket 1A of this embodiment includes the external wiring connection terminal 3 connected to the external wiring, and the electrical device terminal connection terminal 4 connected to the electrical device terminal. Additionally, in the socket 1A, the external wiring connection terminal 3 and the electrical device terminal connection terminal 4 are electrically connected by the bar-shaped wire 2 of which the shape is fixed in a predetermined shape.

Accordingly, automatic assembly becomes possible. Further, in this embodiment, since the inter-terminal connection member is configured with the bar-shaped wire, the bar-shaped wire 2 itself can be formed in a bilaterally symmetrical shape. As a result, material cost can be reduced. The number of mold surfaces can also be drastically reduced to, for example, one.

Further, since the number of types of the bar-shaped wire 2 can be reduced, it is possible to reduce the number of steps in the case of selecting an appropriate bar-shaped wire or the like. Particularly, since common parts are used, automation of assembly can be simplified. Therefore, it is also possible to reduce the number of steps at this point.

Therefore, it is possible to provide the socket 1A capable of efficiently and easily connecting the external wiring connection terminal 3 with the electrical device terminal connection terminal 4 and reducing the manufacturing cost and the number of steps.

Further, in the socket 1A according to this embodiment, the bar-shaped wire 2 is formed in a U-shape. Therefore, it is possible to connect the bar-shaped wire 2 to the external wiring connection terminal 3 and the electrical device terminal connection terminal 4 by pushing both ends of the bar-shaped wire 2 fixed in a U shape upon connection to the external wiring connection terminal 3 and the electrical device terminal connection terminal 4. As a result, even in the case of automatic assembly, the bar-shaped wire 2 can be connected to the external wiring connection terminal 3 and the electrical device terminal connection terminal 4 by moving the bar-shaped wire 2 in one direction. Further, if the inter-terminal connection member is formed into the bar-shaped wire 2, the number of types of the inter-terminal connection member also decreases. For example, when the type of the bar-shaped wire 2 is changed, a length of the horizontal portion 2c of the bar-shaped wire 2, or a length of the long leg 2a and the short leg 2b is changed, and the number of types is also small. Therefore, the automatic assembly is facilitated, the number of steps can be reduced, and the manufacturing cost can be reduced.

Further, in the socket 1A according to this embodiment, the molded support 20A as a molded product for supporting the bar-shaped wire 2 is provided, and the molded support 20A has the groove 22a which fixes the bar-shaped wire 2 in the stationary state in the direction perpendicular to the direction in which the bar-shaped wire 2 is inserted into the molded support 20A. Therefore, the bar-shaped wire 2 does not move in the direction perpendicular to the direction in which the bar-shaped wire 2 is inserted into the molded support 20A due to the groove 22a of the molded support 20A.

Therefore, it is possible to prevent the legs of the bar-shaped wire 2 from being broken or bent when the bar-shaped wire 2 is inserted.

Further, in the socket 1A according to this embodiment, the plurality of bar-shaped wires 2 are provided, and the molded support 20A supports the bar-shaped wire 2 to have a height difference between the bar-shaped wires 2 in the direction in which the bar-shaped wire 2 is inserted into the molded support 20A. For example, a height position of the horizontal portion 2c of at least one bar-shaped wire 2 and a height position of the horizontal portion 2c of at least one of other bar-shaped wires 2 are different from each other. As a result, since the height positions of the plurality of bar-shaped wires 2 are different from each other when the bar-shaped wires 2 are installed and fixed, it is possible to reduce the possibility that the respective bar-shaped wires 2 come into contact with each other. Also, the plurality of bar-shaped wires 2 having different height positions may be disposed to intersect each other. The plurality of bar-shaped wires 2 having the same height positions of the horizontal portions 2c may be disposed.

Further, in the socket 1A according to this embodiment, each of the external wiring connection terminal 3 and the electrical device terminal connection terminal 4 includes the bar-shaped wire insertion hole 3b, and a bar-shaped wire leg clamping plate spring portion 4b as a bar-shaped wire end connection hole which enables electrical connection by inserting each end of the bar-shaped wire 2. Therefore, the bar-shaped wire 2 can be connected to the external wiring connection terminal 3 and the electrical device terminal connection terminal 4 merely by inserting the bar-shaped wire 2 into the bar-shaped wire insertion hole 3b and the bar-shaped wire leg clamping plate spring portion 4b.

Therefore, it is easy to connect the bar-shaped wire 2 to the external wiring connection terminal 3 and the electrical device terminal connection terminal 4, and it is possible to reduce the number of steps.

Further, in the socket 1A according to this embodiment, the rear cover 10 as a cover body having an insulating property is provided, and the rear cover 10 has a rear cover protruding portion 12 as a protrusion which fixes the position of the bar-shaped wire 2 by coming into contact with or pressing or having a gap to the bar wire 2 when it is closed.

Accordingly, when the bar-shaped wire 2 is connected to the external wiring connection terminal 3 and the electrical device terminal connection terminal 4 and then covered with the rear cover 10, the rear cover protruding portion 12 fixes the position of the bar-shaped wire 2 while coming into contact with, or pressing, or having a gap to the bar-shaped wire 2. Therefore, it is possible to prevent the disconnection of the bar-shaped wire 2 from the external wiring connection terminal 3.

### Second Embodiment

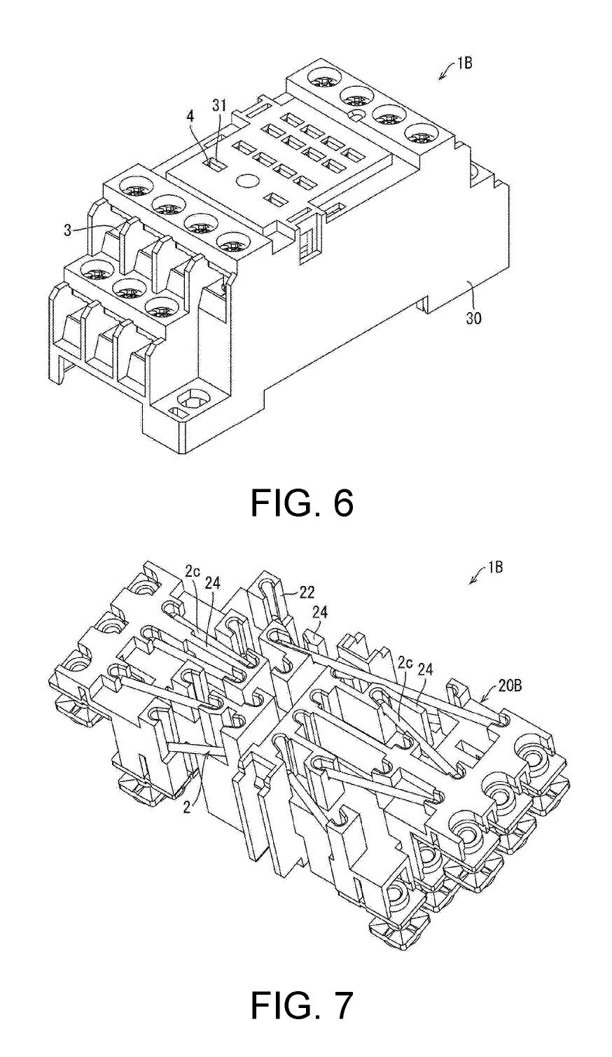

Another embodiment of the disclosure will be described with reference to FIGS. 6 and 7 as follows. Configurations other than those described in this embodiment are the same as those in the first embodiment. Further, for convenience of explanation, members having the same functions as the members shown in the drawings of the first embodiment are designated by the same reference numerals, and description thereof will be omitted.

A socket 1B of this embodiment is different from the socket 1A according to the first embodiment in that insulation walls for insulating the plurality of bar-shaped wires 2 are provided at a molded support 20B as a molded product.

The configuration of the socket 113 of this embodiment will be described with reference to FIGS. 6 and 7. FIG. 6 is a perspective view showing an example of the configuration of the socket 1B according to this embodiment. FIG. 7 is a perspective view showing an example a state in which the molded support 20B and the bar-shaped wire 2 of the socket 1B are seen from the rear side.

As shown in FIG. 6, in the socket 1B of this embodiment, 14 terminal insertion holes 31 are provided in the upper surface of the front cover 30. As a result, 14 electrical device terminal connection terminals 4 and 14 external wiring connection terminals 3 are provided. Therefore, the socket 1B of this embodiment is a 14-terminal type socket. Therefore, a size in the longitudinal direction of the socket 1B is the same as the length in the longitudinal of the socket 1A, while a size in the lateral direction thereof is slightly longer than the length in the lateral direction of the socket 1A.

As described above, when the number of terminals of the electrical device terminal connection terminal 4 and the external wiring connection terminal 3 increases, density of the bar-shaped wires 2 inside the socket 1A also increases, and the possibility that the horizontal portions 2c of the bar-shaped wires 2 come into contact with each other increases.

Therefore, in the socket 1B according to this embodiment, as shown in FIG. 7, insulation walls 24 which insulate the plurality of bar-shaped wires 2 is formed on the molded support 20B as a molded product. Since the insulation wall 24 has a structure of a part of the molded support 20B formed of an insulating resin, it has an insulating property. The insulation wall 24 is formed into, for example, a flat plate. However, in the aspect of the disclosure, the insulation wall 24 is not necessarily formed into a flat plate and may be, for example, a columnar shape. As a result, as shown in FIG. 7, the insulation wall 24 may partition all of the length of the horizontal portion 2c of the bar-shaped wire 2, but it may partition a part of the length of the horizontal portion 2c of the bar-shaped wire 2.

As described above, in the socket 1B according to this embodiment, the molded support 20B includes the insulation walls 24 which insulate the plurality of bar-shaped wires 2. Accordingly, it is possible to prevent short-circuiting of the bar-shaped wires 2 due to the insulation walls 24.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A socket comprising an external wiring connection terminal which is connected to an external wiring and an electrical device terminal connection terminal which is connected to an electrical device terminal,
wherein the external wiring connection terminal and the electrical device terminal connection terminal are electrically connected by a bar-shaped wire of which a shape is fixed to a predetermined shape.

2. The socket according to claim 1, wherein the bar-shaped wire is formed in a U-shape.

3. The socket according to claim 2, wherein a molded product which supports the bar-shaped wire is provided, and the molded product has a groove or hole which fixes the bar-shaped wire in a stationary state in a direction perpendicular to a direction in which the bar-shaped wire is inserted into the molded product.

4. The socket according to claim 3, wherein a plurality of bar-shaped wires are provided, and the molded product supports the bar-shaped wires to have a height difference between the bar-shaped wires in a direction in which the bar-shaped wire is inserted into the molded product.

5. The socket according to claim 3, wherein a plurality of bar-shaped wires are provided, and the molded product has insulation walls which insulate the plurality of bar-shaped wires.

6. The socket according to claim 1, wherein each of the external wiring connection terminal and the electrical device terminal connection terminal has a bar-shaped wire end connection hole which enables electrical connection by inserting each end of the bar-shaped wire.

7. The socket according to claim 1, wherein a cover body having an insulating property is provided, and the cover body has a protrusion which fixes a position of the bar-shaped wire when the cover body is closed.

8. The socket according to claim 2, wherein each of the external wiring connection terminal and the electrical device terminal connection terminal has a bar-shaped wire end connection hole which enables electrical connection by inserting each end of the bar-shaped wire.

9. The socket according to claim 3, wherein each of the external wiring connection terminal and the electrical device terminal connection terminal has a bar-shaped wire end connection hole which enables electrical connection by inserting each end of the bar-shaped wire.

10. The socket according to claim 4, wherein each of the external wiring connection terminal and the electrical device terminal connection terminal has a bar-shaped wire end connection hole which enables electrical connection by inserting each end of the bar-shaped wire.

11. The socket according to claim 5, wherein each of the external wiring connection terminal and the electrical device terminal connection terminal has a bar-shaped wire end connection hole which enables electrical connection by inserting each end of the bar-shaped wire.

12. The socket according to claim 2, wherein a cover body having an insulating property is provided, and the cover body has a protrusion which fixes a position of the bar-shaped wire when the cover body is closed.

13. The socket according to claim 3, wherein a cover body having an insulating property is provided, and the cover body has a protrusion which fixes a position of the bar-shaped wire when the cover body is closed.

14. The socket according to claim 4, wherein a cover body having an insulating property is provided, and the cover body has a protrusion which fixes a position of the bar-shaped wire when the cover body is closed.

15. The socket according to claim 5, wherein a cover body having an insulating property is provided, and the cover body has a protrusion which fixes a position of the bar-shaped wire when the cover body is closed.

16. The socket according to claim 6, wherein a cover body having an insulating property is provided, and the cover body has a protrusion which fixes a position of the bar-shaped wire when the cover body is closed.
